(19) United States
(12) Patent Application Publication
(10) Pub. No.: US 2025/0231287 A1
(43) Pub. Date: Jul. 17, 2025

(54) METHOD AND DEVICE FOR ASCERTAINING A VISUAL RANGE DEGRADATION OF A LIDAR SYSTEM AS WELL AS A COMPUTER PROGRAM AND A MACHINE-READABLE STORAGE MEDIUM

(71) Applicant: Robert Bosch GmbH, Stuttgart (DE)

(72) Inventors: Annette Frederiksen, Renningen (DE); Mustafa Kamil, Ludwigsburg (DE)

(21) Appl. No.: 18/727,845

(22) PCT Filed: Jan. 25, 2023
(86) PCT No.: PCT/EP2023/051728

§ 371 Date: Jul. 10, 2024

(30) Foreign Application Priority Data
Feb. 3, 2022 (DE) 10 2022 201 123.6

(51) Int. Cl. G01S 7/497; G01S 17/89

(52) U.S. Cl. CPC G01S 7/497; G01S 17/89

(57) ABSTRACT

A method for ascertaining a visual range degradation of a LiDAR system. The method includes: providing a data point cloud of a LiDAR system that maps objects in the field of view of the LiDAR system; analyzing at least a portion of the data point cloud to ascertain an edge dimension of at least one object in the data point cloud; and ascertaining a visual range of the LiDAR system and/or initiating a process for degradation correction for the LiDAR system based on the edge dimension. A corresponding device for ascertaining a visual range degradation of a LiDAR system, as well as a computer program and a machine-readable storage medium, are also described.

### FIELD

The present invention relates to a method for ascertaining a visual range degradation of a LiDAR system.

### BACKGROUND INFORMATION

A LiDAR system can be based on a variety of measurement principles. A very significant source of performance degradation for almost all LiDAR sensor principles in their various areas of application are disturbances in their ambient medium, e.g., due to atmospheric effects, e.g., weather events such as rain, snow or fog.

Also, solid particles, so-called aerosols, e.g., smoke or soot, and artificially generated non-solid particles, such as spray, vapors or snowdrifts, for instance produced by other vehicles traveling in front of the ego vehicle comprising the LiDAR system. These natural and non-natural effects lead to a deterioration of the performance of a LiDAR system by scattering and absorbing the optical radiation.

The perception of the surroundings is impaired, which has a direct effect on safety-related performance parameters. For use as one of the primary sensors for automated driving, impaired propagation of laser light in the atmosphere is a serious problem that is also unavoidable in real-world applications.

This makes reliable identification and quantification of a reduced field of view urgently necessary to maintain the safety and reliability of the automated driving function. This can be used to estimate the degraded sensor performance in the current driving situation and the atmospheric sensitivity, so that system degradation can be identified and reported to the automated driving function via the interface of the LiDAR system and to the cleaning unit to remedy the degradation (e.g. soiling or wetting).

A very simple response to reduced sensor performance is reducing the driving speed of the vehicle or leaving the lane in order to achieve a safe state with an automated vehicle. Even better would be activating a cleaning unit to clean the cover glass of the LiDAR system and remove optical interference.

U.S. Patent Application Publication No. US 2019/0258251 describes a system that identifies malfunctions of a LiDAR system by means of edge detection and, if necessary, initiates a cleaning of the system.

U.S. Pat. No. 9,677,986 describes a method for detecting particles in the ambient air by means of edge detection using a LiDAR system.

### SUMMARY

Disclosed is a method for ascertaining a visual range degradation of a LiDAR system according to the present invention.

According to an example embodiment of the present invention, a data point cloud of a LiDAR system is provided, which maps or represents objects in the field of view of the LiDAR system.

At least a portion of the data point cloud is analyzed to ascertain an edge dimension of at least one object in the data point cloud.

Based on the edge dimension, a visual range of the LiDAR system is ascertained and/or a process for degradation correction is started. This can be done if a predefined edge dimension limit value is exceeded, for example.

This is advantageous because the method can easily and cost-efficiently be implemented on a LiDAR system and requires only a small amount of computational effort. The method moreover advantageously ensures safe and reliable functioning of the LiDAR system or takes appropriate measures to correct the degradation.

Further advantageous embodiments of the present invention are disclosed herein.

The method can be computer-implemented.

According to an example embodiment of the present invention, the analysis of at least a portion of the data point cloud expediently includes the use of an edge detection algorithm. In particular a filter, for example a Sobel filter, can be used here. This is advantageous to easily ascertaining the edge dimension.

The edge dimension expediently comprises an edge sharpness-to-frequency histogram, an edge length histogram, an average edge length, an edge density per solid angle, an interruption rate of real continuous edges and/or a standard deviation of said dimensions. This is advantageous because it ensures a simple implementation of the method.

There is expediently a check to see whether the edge dimension exceeds or falls below a predefined limit value. This is advantageous because the predefined limit value can be predefined depending on the application, which enables easy adaptation.

The analysis of the at least a portion of the data point cloud is expediently carried out in three spatial dimensions. This is advantageous because, compared to a two-dimensional image, the additional information of the third dimension obtained by the

LiDAR system can be used, as a result of which a more accurate and reliable analysis of the data point cloud is carried out.

Another example embodiment of the present invention includes a computer program which is configured to execute all steps of the method according to one of the preceding example embodiments. This makes simple use of the present invention possible and the abovementioned advantages are realized.

Another example embodiment of the present invention includes a machine-readable storage medium on which the computer program is stored. This makes simple distribution of the computer program possible and the abovementioned advantages can be realized.

Another example embodiment of the present invention is a device for ascertaining a visual range degradation which comprises at least one means configured to carry out the steps of the method according to the present invention. The at least one means can be an electronic control unit, for example.

The means expediently comprises a LiDAR system. This is advantageous to enable simple use of the system.

### BRIEF DESCRIPTION OF THE DRAWINGS

Advantageous embodiments of the present invention are shown in the figures and explained in more detail in the following description.

FIG. 1 shows a flow chart of a method according to the present invention according to an example embodiment.

FIG. 2 shows a schematic illustration of a real environment in which the method according to the present invention can advantageously be used.

FIG. 3 shows a schematic illustration of a device according to the present invention according to one example embodiment.

### DETAILED DESCRIPTION OF EXAMPLE EMBODIMENTS

In all figures, identical reference signs denote identical device components or identical method steps.

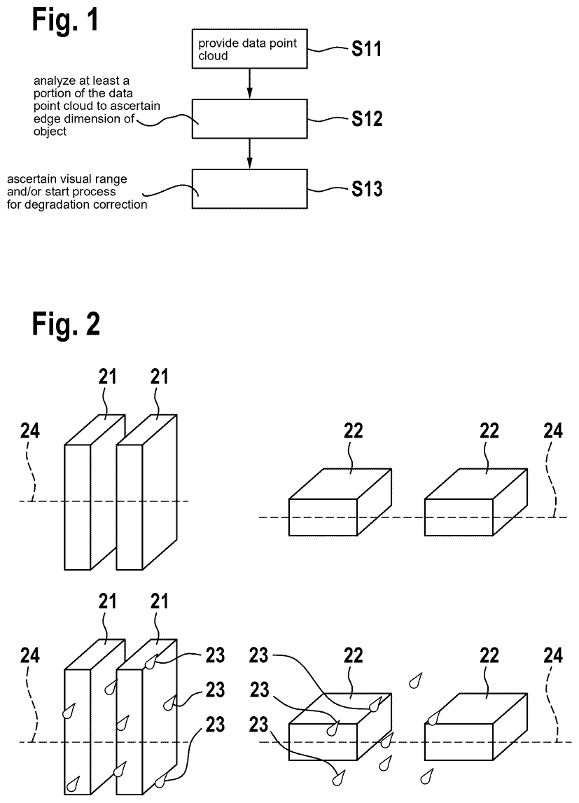

FIG. 1 shows a flow chart of a method according to the present invention according to an embodiment. In a first step S11, a data point cloud of a LiDAR system is provided, wherein the data point cloud maps objects in the field of view of the LiDAR system.

In an undisturbed, optically clear medium or atmosphere, the edges of the objects are clearly distinguishable from their background in three-dimensional acquisition in a data point cloud. The edges can be identified using appropriate image processing algorithms, an example of which is the Sobel filter.

In a disturbed atmosphere, for example in rain, fog, dense vapor, aerosols, spray, dust, sand, the particles reflect laser light just like solid objects do. Their reflections will be dense in particular in the immediate vicinity of the LiDAR system or the objects in the space, because the optical radiation is concentrated in these locations.

In a second step S12, at least a portion of the data point cloud is analyzed to ascertain an edge dimension of at least one object in the data point cloud.

The sharpness of the mapped object edges will be different in the case of a disturbed and undisturbed scene. The greater the atmospheric disturbance, the lower the edge sharpness of the mapped objects. Each object in the field of view of the LiDAR system will have more or less easily identifiable and possibly blurred edges depending on the atmospheric transmission in the 3D point cloud. This can then easily be differentiated mathematically, for example using a Sobel filter. In a three-dimensional point cloud, the filter can advantageously be mapped three-dimensionally, so that edge detection can be calculated in width and also in height and depth.

As a result, the number and sharpness of the detected edges can be statistically aggregated, for example using an edge sharpness-to-frequency histogram of multiple LiDAR images, i.e. multiple data point clouds. A mark identified as sharp can be classified as sharp based on a threshold value of the edge detection algorithm. The lengths of the edges in the three-dimensional point cloud can be determined as well, and aggregated in an edge length histogram. Another measure of atmospheric disturbance correlated with the edge length count is the interruption rate of real continuous edges by discrete aerosol or precipitation types, e.g. dust, rain or snow. In the case of homogeneous disturbances, such as soiling of the sensor cover glass or fog, the number of edges classified as sharp decreases rapidly. Other countable characteristics can be derived from the descriptive statistics, for example the average edge length or the spatial or temporal edge density per solid angle in the field of view. It is additionally also possible to use the standard deviation of these variables or the standard deviation of the edge profiles in the three-dimensional point cloud.

In a third step S13, a visual range of the LiDAR system is ascertained and/or a process for degradation correction is started based on the edge dimension. If it is detected, for example based on the edge dimension, that the visual range of the LiDAR system is restricted due to raindrops, cleaning the LiDAR system or a cover glass of the LiDAR system through which the laser light is emitted can at least partially eliminate said restriction.

FIG. 2 shows a schematic illustration of a real environment in which the method according to the present invention is advantageously being used. The dashed lines indicate the respective horizontal axis 24 of the LiDAR system. The upper part of FIG. 2 shows a respective undisturbed scene with two adjacent objects 21, 22, for example house walls, cars, poles or the like. The lower part of FIG. 2 shows the same respective scene with atmospheric disturbances 23, for example rain drops or fog droplets. In the lower part, frequently blurred edges in a data point cloud of a LiDAR system are to be expected.

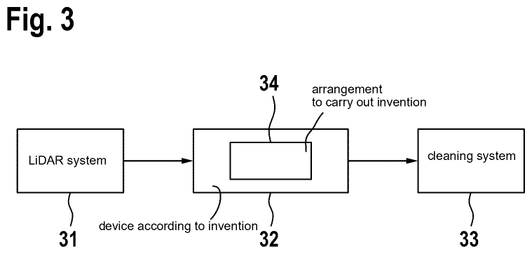

FIG. 3 shows a schematic illustration of a device 32 according to the present invention according to one embodiment. The device 32 comprises at least one means 34 which is configured to carry out the steps of a method according to the present invention. A LiDAR system 31 ascertains the data point cloud and provides it to the device 32. The device 32 analyzes at least a portion of the data point cloud and then initiates a process for degradation correction by a cleaning system 33.

1-9. (canceled)

10. A method for ascertaining a visual range degradation of a LiDAR system, comprising the following steps:
a. providing a data point cloud of a LiDAR system that maps objects in a field of view of the LiDAR system;
b. analyzing at least a portion of the data point cloud to ascertain an edge dimension of at least one object in the data point cloud; and
c. (i) ascertaining a visual range of the LiDAR system based on the edge dimension and/or (ii) initiating a process for degradation correction for the LiDAR system based on the edge dimension.

11. The method according to claim 10, wherein the analysis in step b) includes use of an edge detection algorithm which includes a filter.

12. The method according to claim 10, wherein the edge dimension includes an edge sharpness-to-frequency histogram, and/or an edge length histogram, and/or an average edge length, and/or an edge density per solid angle, and/or an interruption rate of real continuous edges, and/or a standard deviation of said dimensions.

13. The method according to claim 10, wherein, in step c), there is a check to see whether the edge dimension exceeds or falls below a predefined limit value.

14. The method according to claim 10, wherein the analysis in step b) is carried out in three spatial dimensions.

15. A non-transitory machine-readable storage medium on which is stored a computer program for ascertaining a visual range degradation of a LiDAR system, the computer program, when executed on a computer, causing the computer to perform the following steps:
a. providing a data point cloud of a LiDAR system that maps objects in a field of view of the LiDAR system;
b. analyzing at least a portion of the data point cloud to ascertain an edge dimension of at least one object in the data point cloud; and
c. (i) ascertaining a visual range of the LiDAR system based on the edge dimension and/or (ii) initiating a process for degradation correction for the LiDAR system based on the edge dimension.

16. A device for ascertaining a visual range degradation, comprising:
an arrangement configured to ascertain a visual range degradation of a LiDAR system, the arrangement configured to:
a. provide a data point cloud of a LiDAR system that maps objects in a field of view of the LiDAR system;
b. analyze at least a portion of the data point cloud to ascertain an edge dimension of at least one object in the data point cloud; and
c. (i) ascertain a visual range of the LiDAR system based on the edge dimension and/or (ii) initiate a process for degradation correction for the LiDAR system based on the edge dimension.

17. The device according to claim 16, wherein the arrangement includes the LiDAR system.
